(19) United States
(12) Patent Application Publication
(10) Pub. No.: US 2024/0391652 A1
(43) Pub. Date: Nov. 28, 2024

(54) Container and Seal Assembly

(71) Applicant: BWAY Corporation, Atlanta, GA (US)

(72) Inventors: Frano LUBURIC, Costa Mesa, CA (US); Forrest A. Burney, LaGrange, GA (US)

(21) Appl. No.: 18/791,543

(22) Filed: Aug. 1, 2024

Related U.S. Application Data
(63) Continuation of application No. PCT/US2022/041891, filed on Aug. 29, 2022.

(51) Int. Cl. B65D 43/06; B65D 1/16; B65D 21/02; B65D 53/02

(52) U.S. Cl. CPC B65D 43/06; B65D 1/16; B65D 21/0219; B65D 53/02; B65D 2543/00092; B65D 2543/0024; B65D 2543/00296; B65D 2543/00435; B65D 2543/00972

(57) ABSTRACT

The present disclosure relates generally to container systems comprising a container, a container ring, and a container lid. In one or more embodiments, the disclosed container systems use novel designs to provide a liquid-tight seal without the use of gaskets or adhesives. For example, in several embodiments, the container attaches to the container ring, and the container ring attaches to the container lid via a snap-fit assembly to facilitate reduced seams and increased sealing capability without the use of adhesives or additional sealing materials or components.

### CROSS REFERENCE TO RELATED APPLICATIONS

This application is a continuation of, and claims the benefit of, and priority to, International Patent Application No. PCT/US2022/041891, filed Aug. 29, 2022, and entitled “Container and Seal Assembly.”

This application hereby incorporates by reference U.S. Design patent application Ser. No. 29/851,474, entitled “Container Ring,” filed Aug. 29, 2022; U.S. Design patent application Ser. No. 29/851,476, entitled “Container Ring,” filed Aug. 29, 2022; U.S. Design patent application Ser. No. 29/851,477, entitled “Container Lid,” filed Aug. 29, 2022; and U.S. Design patent application Ser. No. 29/851,479, entitled “Container Lid,” filed Aug. 29, 2022, the contents of which are hereby incorporated by reference in their entireties as if the same were fully set forth herein.

### TECHNICAL FIELD

The present disclosure relates generally to containers, rings, and lids.

### BACKGROUND

Containers are a widely used component in a variety of industries. Wholesalers, merchants, and individuals use containers in a plethora of industries including, but not limited to: manufacturing, agriculture, beverage, entertainment, health care, food services, hospitality, fishing, retail, automotive, transportation, waste management, oil and gas, education, and construction. The paint industry in particular, as a liquid-based industry, heavily depends on containers for the majority of its packing, storing, and shipping requirements. As such, improvements to the cost of paint- and other liquid-carrying containers may account for significant cost savings to a company's bottom line.

Often, containers and lids may require adhesives or additional sealing materials to create a liquid-tight seal. Adhesives and additional sealing materials substantially raise the cost and time necessary to produce containers and lids. Therefore, there is a long-felt but unresolved need for containers and lids that may form a liquid-tight seal that does not require the use of adhesive or additional scaling materials.

### BRIEF SUMMARY OF THE DISCLOSURE

Briefly described, and according to one embodiment, aspects of the present disclosure generally relate to containers and lids, and more particularly to containers including a separate ring and associated lid. The present disclosure discusses a novel and unique container that provides several improvements over existing, traditional containers in the paint and other industries that use containers, including, but not limited to: manufacturing, agriculture, beverage, entertainment, health care, food services, hospitality, fishing, retail, automotive, transportation, waste management, oil and gas, education, and construction. In various embodiments, the containers discussed herein have a lower cost of production and require less time to assemble than traditional containers for storing similar goods. In at least one embodiment, the present container includes a separate ring, which, in combination with the container design, may substantially eliminate the use of adhesives and additional sealing materials. In this embodiment and others, the present container may be assembled by applying pressure or force to the container or ring, either alone or in combination. Further, the lid may be attached to the container by applying pressure or force to the container, ring, or lid, either alone or in combination. Eliminating the need for adhesives and additional sealing materials allows the containers to be produced entirely out of plastic (e.g., Polyethylene, Polyethylene Terephthalate (PET), High-Density Polyethylene (HDPE), Polyvinyl Chloride (PVC), Low-Density Polyethylene (LDPE), Polypropylene (PP), Polystyrene (PS), etc.).

The above and further features of the disclosed example container systems and assemblies (e.g., including a container, a ring, and a lid) will be recognized from the following detailed descriptions and drawings of particular embodiments. For example, the disclosed technology includes a container assembly that can include a container that can include a bottom surface and at least one sidewall circumscribing the bottom surface. The at least one sidewall can extend in a vertical direction from the bottom surface to an upper end thereby forming a cavity. The upper end can include an attachment portion and a latch tab extending from the attachment portion in a radial direction. The container assembly can include a ring that can include a container latch channel configured to at least partially receive the attachment portion of the container; the container latch channel can include an outer container latch channel (CLC) side, an inner CLC side, and a top CLC side. The ring can include a lid latch configured to engage a lid; the lid latch can include an inner lid latch side, a distal lid latch edge, and an outer lid latch side. The ring can include a bottom wall extending between the inner CLC side and the outer lid latch side. At least the inner CLC side, the bottom wall, and the outer lid latch side form a lid latch channel (i.e., the lid latch channel is formed by at least the inner CLC side, the bottom wall, and the outer lid latch side). The lid can include a ring latch channel configured to at least partially receive the lid latch of the ring. The latch tab can be configured to fold downwardly when the container latch channel at least partially receives the sidewall.

In some embodiments, the container latch channel can include a CLC protrusion extending from the top CLC side into the container latch channel. The CLC protrusion can be configured to engage the upper end of the container. The CLC protrusion can be substantially rectangular in shape. The outer CLC side can include one or more latch surfaces including a sloped surface extending in a sloped direction into the container latch channel. The sloped surface can form at least part of a latch protrusion for engaging latch tab. The latch protrusion can have a substantially trapezoidal cross-sectional shape. In certain embodiments, the ring can further include an underside surface, and an edge between the inner CLC side and the underside surface can be rounded or chamfered. The bottom surface can be substantially circular. Alternatively or in addition, the bottom surface can be substantially round. Alternatively or in addition, the bottom surface can be substantially rectangular. In some embodiments, a thickness of the at least one sidewall of the container can be less than a width of the container latch channel. Generally, the container can be a first single component, the ring can be a second single component, and the lid can be a third single component. Attachment of the ring to the container can form a liquid-tight seal between the ring and the container. Alternatively or in addition, attachment of the lid to the ring forms a liquid-tight seal between the lid and the ring. Accordingly, the combination of the container, the ring, and the lid can form a liquid-tight container assembly.

The disclosed technology includes a system for sealing a container, and the system can include a ring configured to engage the container. The ring can include a container latch channel configured to accept a portion of the container and a lid latch configured to engage with a lid. The lid latch can include an inner lid latch side and an outer lid latch side, and at least a portion of the lid latch can extend in a radial direction. The ring can include a bottom wall extending between an inner wall of the container latch channel and the lid latch, and at least the inner wall of the container latch channel, the bottom wall, and the lid latch can form a lid latch channel. The lid can include a ring latch channel configured to at least partially receive the lid latch of the ring. The ring latch channel can include an inner ring latch sidewall, an outer ring latch sidewall, and a top ring latch surface. A width of the inner ring latch sidewall can increase from a first diameter at a bottom of the inner ring latch sidewall to second diameter at a latch notch and can decrease from the second diameter to a third diameter proximate the top ring latch surface.

In some embodiments, an upper portion of the outer lid latch side can be substantially convex. The top ring latch surface can be substantially rounded. The radial direction can be radially outward. The inner ring latch sidewall can include a ridged surface. The ring can further include a ring bead protrusion on the outer lid latch side, and the ring bead protrusion can extend into the lid latch channel. The ring bead protrusion can have a substantially trapezoidal cross-sectional shape. The inner ring latch sidewall can include a recess configured to at least partially receive and/or engage the ring bead protrusion. The outer ring latch sidewall can include a latch protrusion configured to engage the ring latch channel.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is an exploded view of an exemplary container, ring, and lid according to one embodiment of the present disclosure;

FIG. 2 is a perspective view of an exemplary ring, according to one embodiment of the present disclosure;

FIG. 3A is a cross-sectional view of an exemplary container and ring in a separated configuration, according to one embodiment of the present disclosure;

FIG. 3B is a cross-sectional view of an exemplary ring immediately prior to engaging an exemplary container, according to one embodiment of the present disclosure;

FIG. 3C is a cross-sectional view of an exemplary container and ring in an attached configuration, according to one embodiment of the present disclosure;

FIG. 4 is a cross-sectional view of an exemplary container and ring in an attached configuration, according to one embodiment of the present disclosure;

FIG. 5 is a perspective view of an exemplary lid, according to one embodiment of the present disclosure;

FIG. 6A is a cross-sectional view of an exemplary container and ring immediately prior to engaging an exemplary lid, according to one embodiment of the present disclosure;

FIG. 6B is a cross-sectional view of an exemplary container, ring, and lid in an attached configuration, according to one embodiment of the present disclosure;

FIG. 7A is a cross-sectional view of an exemplary container and ring immediately prior to engaging an exemplary lid, according to one embodiment of the present disclosure;

FIG. 7B is a cross-sectional view of an exemplary container, ring, and lid in an attached configuration, according to one embodiment of the present disclosure;

FIG. 8 is a cross-sectional view of an exemplary container stacked on top of a container, ring, and lid in an attached configuration, according to one embodiment of the present disclosure; and

FIG. 9 is a cross-sectional view of an exemplary container stacked on top of a container, ring, and lid in an attached configuration, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

The above and further features of the disclosed exemplary container, ring, and lid will be recognized from the following detailed descriptions and drawings of particular embodiments. In various embodiments, a container with a rim is disclosed. In particular embodiments, the container includes a container body (e.g., external wall) that forms the outer casing of the container. In particular embodiments, the container (e.g., the container rim) includes one or more seal surfaces to provide enhanced sealing properties when engaged with a ring and sealed with a lid. In particular embodiments, the container rim includes a latch tab that engages with corresponding seal structures on the ring to form a liquid-tight seal without any adhesives or additional sealing materials.

In at least one embodiment, a ring is disclosed for engaging a container and lid. In some embodiments, the ring includes a u-shaped channel. In some embodiments, the ring includes a rectangular or trapezoidal shaped channel. According to at least one embodiment, the channel on the ring engages with the latch tab on the container to form a liquid-tight seal without any adhesives or additional sealing materials (e.g., gaskets).

In particular embodiments, the ring includes one or more sidewalls including one or more seal surfaces for facilitating a liquid-tight seal when engaged with a container or lid. In some embodiments, the ring includes a ring bead for engaging a corresponding structure on a lid. In several embodiments, the ring includes a rounded top for engaging a corresponding structure on a lid. In various embodiments, the top may be trapezoidal, triangular, or any other suitable shape to facilitate the functionality described herein. In certain embodiments, the ring includes a channel for engaging a corresponding structure on a container. According to at least one embodiment, the ring is circular in shape. In at least one embodiment, the ring is square or rectangular in shape.

Furthermore, a lid is disclosed for engaging a ring. In various embodiments, the lid includes one or more seal surfaces to provide enhanced sealing properties when scaling a container (e.g., ring). In particular embodiments, the lid includes a notch for engaging a corresponding ring bead on a ring to facilitate a liquid-tight seal. In at least one embodiment, the lid includes both a notch and protrusion for engaging a corresponding rounded top on a ring to facilitate a liquid-tight seal. In one or more embodiments, the lid may be manufactured to fit any container shape (e.g., rectangular, ovoid, etc.). According to at least one embodiment, the lid is circular in shape. In at least one embodiment, the lid is square or rectangular in shape.

The container, ring, and lid discussed herein may be formed in any suitable way. In various embodiments, the container, ring, and lid are formed by injection molding. In particular embodiments, the container, ring, and lid are 3D printed or created via another additive manufacturing technique. In further embodiments, various components of the container, ring, and/or lid are formed or created separately, and the various corresponding components of the container, ring, and/or lid are joined or otherwise suitably connected to form the container, ring, and/or lid. In one embodiment, the container, ring, and/or lid may each be one piece and unitary.

The container, ring, and lid may be formed from any suitable material or materials for storing or transporting such materials. In various embodiments, the container, ring, and/or lid are manufactured from metal or composite material. In particular embodiments, the container, ring, and/or lid are manufactured from plastic (e.g., Polyethylene, High-Density Polyethylene, etc.). At least one of the container, ring, or lid can be made from and/or comprise a different material than at least one other of the container ring, or lid. As an illustrative example, the container can be made from and/or comprise a metal, the ring can be made from and/or comprise plastic, and the lid can be made from and/or comprise a metal or a plastic.

As will be understood by one of ordinary skill in the art, the container, ring, and lid discussed herein may be used for storing and sealing any variety of materials, including, but not limited to: paints, oils, food, consumer goods, construction materials, inks, chemicals, lubricants, adhesives, coatings, roofing mastics, driveway sealers, flavorings, sanitation supplies, building products, ice melt compounds, powders, pet food, and other such materials.

As will be understood by one of ordinary skill in the art, the container, ring, and lid discussed herein may form a liquid-tight seal that requires no adhesives or additional scaling materials (e.g., gaskets). This liquid-tight seal may be formed simply by lining up container, ring, and lid, and applying pressure or force to the container, ring, or lid, either alone or in combination. No adhesives or additional sealing materials are necessary to attach container to ring or the lid to the ring. This liquid-tight seal provides significant advantages such as decreasing the cost of production and materials and the time necessary to assemble.

### Exemplary Embodiments

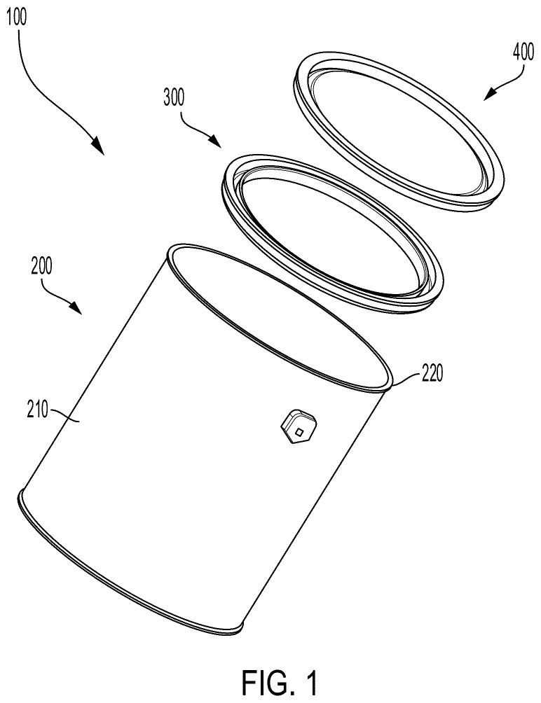

Turning now to FIG. 1, an exploded view of an exemplary container assembly 100 includes a container 200, ring 300, and lid 400 and is shown according to one embodiment of the present disclosure. In some embodiments, the container 200, ring 300, and lid 400 are circular in shape. In various embodiments, the container 200, ring 300, and lid 400 may be rectangular, square, or trapezoidal in shape. In various embodiments, the ring 300 attaches to the container 200 to facilitate a liquid-tight seal without any adhesives or additional sealing materials. In one or more embodiments, the ring 300 attaches to the container 200 by placing the bottom of the ring 300 snugly around the rim of the container 200 (as further discussed herein). Ring 300 interfaces with the rim of container 200 to snap securely into place. In one or more embodiments, the lid 400 attaches to the ring 300 by placing the bottom of the lid 400 snugly inside the ring 300 (as further discussed herein). Lid 400 interfaces with the inside of ring 300 to snap securely in place. When ring 300 is attached to container 200, and lid 400 is attached to ring 300, the ring 300, container 200, and lid 400 form an enclosed space with a liquid-tight scal without any adhesives or additional sealing materials (e.g., gaskets). In certain embodiments, the ring 300, container 200, and lid 400 are manufactured out of plastic (e.g., Polyethylene, Polyethylene Terephthalate (PET), High-Density Polyethylene (HDPE), Polyvinyl Chloride (PVC), Low-Density Polyethylene (LDPE), Polypropylene (PP), Polystyrene (PS), etc.). In some embodiments, the ring 300, container 200, and lid 400 may be manufactured out of any material suitable to facilitate the functionality described herein.

In one embodiment, and as shown in FIG. 1, the container 200 includes a container body 210 and container rim 220. In some embodiments, the container body 210 may include graphical information (e.g., signage or label). In various embodiments, the container body 210 terminates at an open end, whereby the open end includes a container rim 220. In circular embodiments, the diameter of container 200 may be any suitable distance (e.g., 5.3-18.7 inches). In various embodiments, the height of container 200 may be any suitable distance (e.g., 4.5-30.9 inches). In various embodiments, the thickness of container body 210 may be any suitable width (e.g., 0.05-0.40 inches).

In circular embodiments, the diameter of ring 300 may be any suitable distance (e.g., 4.7-18.9 inches). In various embodiments, the height of ring 300 may be any suitable distance (e.g., 0.3-0.5 inches). In circular embodiments, the diameter of lid 400 may be any suitable distances (e.g., 4.5-18.3 inches). In various embodiments, the height of lid 400 may be any suitable distances (e.g., 0.2-0.5 inches).

In certain embodiments, and as will be further discussed herein, the container rim 220 includes sealing components to facilitate a liquid-tight seal when engaged with a ring 300. In one or more embodiments, container rim 220 includes a latch channel to engage with corresponding sealing components on ring 300. For example, the corresponding sealing components on container 200 and ring 300 may be aligned and engage with each other to provide a liquid-tight seal when pressed together (e.g., in a snap-fit assembly) or otherwise attached. According to various embodiments, lid 400 may also include sealing components to facilitate a liquid-tight seal without any adhesives or additional sealing materials when engaged with ring 300. In one or more embodiments, lid 400 and ring 300 have corresponding latch channels that align and engage each other. For example, the corresponding sealing components on lid 400 and ring 300 may be aligned and engage with each other to provide a liquid-tight seal when pressed together (e.g., in a snap-fit assembly). When container 200, ring 300, and lid 400 are in attached configuration, container 200, ring 300, and lid 400 form an enclosed cavity with a liquid-tight seal for storing various substances, including liquids.

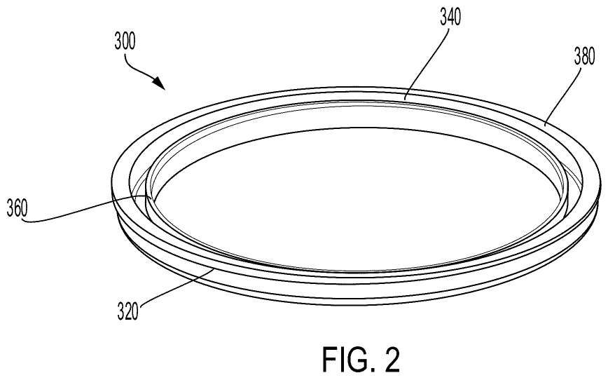

Now referring to FIG. 2, a perspective view of an exemplary ring 300 is shown. According to various embodiments and to be discussed further herein, ring 300 engages with container 200 (as discussed in relation to FIG. 1) to form a liquid-tight seal without any adhesives or additional sealing materials (e.g., gaskets). In various embodiments, ring 300 includes two channels: container latch channel 320 and lid latch channel 340. According to various embodiments, container latch channel 320 and/or lid latch channel 340 may be U-shaped, trapezoidal, or rectangular in shape. Container latch channel 320 and lid latch channel 340 can have the same shape, or container latch channel 320 and lid latch channel 340 can have different shapes. In at least one embodiment, container latch channel 320 is located on the outer portion of ring 300 and lid latch channel 340 is located on the inner portion of ring 300. That is to say, the container latch channel 320 can have a diameter (or other dimension(s) if the container latch channel 320 does not have a circular shape) that is greater than the diameter of the lid latch channel 340 (or other dimension(s) if the lid latch channel 340 does not have a circular shape). Furthermore, container latch channel 320 can be open on the bottom side of ring 300, while lid latch channel 340 can be open on the top side of ring 300. As will be understood from discussions herein, both container latch channel 320 and lid latch channel 340 facilitate a liquid-tight seal.

In one or more embodiments, ring 300 includes top wall 380 located on the top side of ring 300. In various embodiments, top wall 380 at least partially forms the top of container latch channel 320 and ends at the edge of lid latch channel 340. In certain embodiments, ring 300 further includes edge 360 located on the inside of ring 300. In various embodiments, at least a portion of the inner wall of lid latch channel 340 has a trapezoidal cross-sectional shape, which is at least partially defined by edge 360.

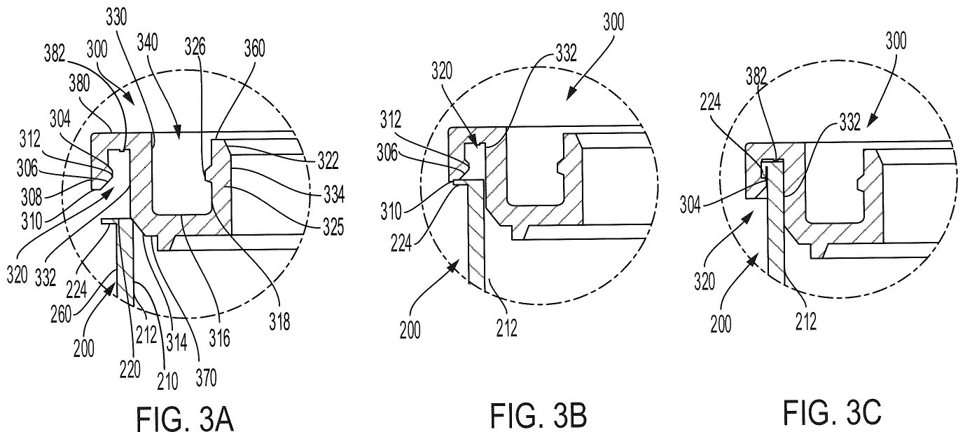

FIG. 3A-3C generally depict the incremental steps of an exemplary ring 300 as it is attached to a container 200, according to one embodiment of the present disclosure. Turning to FIG. 3A, a cross-sectional view of an exemplary ring 300 and container 200 in a separated configuration is shown. As shown in FIG. 3A, as discussed in reference to FIG. 1, container 200 may include a container body 210 and container rim 220. In various embodiments, the container 200 includes sidewall 212 with an outer surface 260. In certain embodiments, sidewall 212 extends upward from the container bottom and transitions into a container rim 220 at the upper end of the container 200. As discussed above in reference to FIG. 1, the thickness of sidewall 212 may be any suitable distance (e.g., 0.06-0.20 inches).

In one or more embodiments, the container rim 220 extends outward (e.g., in a radially outward direction) from the sidewall 212 to form a lip or latch tab 224. Although not illustrated, the container rim 220 can include a latch tab 224 that extends inwardly (e.g., in a radially inward direction) from the sidewall 212 alternatively or in addition to a latch tab 224 extending outwardly. In various embodiments, latch tab 224 is a flat protrusion around the edge of container rim 220. In various embodiments, latch tab 224 has a thickness less than the thickness of sidewall 212. In some embodiments, latch tab 224 may have a thickness equal to, or greater than the thickness of sidewall 212. In at least one embodiment, latch tab 224 engages with a corresponding seal structure on ring 300, such that a liquid-tight seal may be formed between ring 300 and container 200. In certain embodiments, latch tab 224 is manufactured out of a flexible material such that latch tab 224 may fold down or otherwise deform. Alternatively or in addition, the latch tab 224 can be elastically deformable (i.e., the latch tab 224 can be configured to return to its original shape, position, or state upon removal of a deforming force).

In particular embodiments, the ring 300 includes container latch channel 320 formed at least in part by two sidewalls 308, 330 and a top wall 380, such as is shown in FIG. 3A. The container latch channel 320 can include one or more interior surfaces 332 (e.g., defined by the surface(s) of sidewall 308, sidewall 330, and/or top wall 380). In various embodiments, container latch channel 320 may be U-shaped. In some embodiments, container latch channel 320 may have a trapezoidal or rectangular cross-sectional shape. As will be understood from discussions herein, container latch channel 320 is configured to at least partially receive container rim 220 to create a seal between container 200 and ring 300. The width of container latch channel 320 may be any suitable distance that allows for container latch channel 320 to receive container rim 220 (e.g., 0.05-0.10 inches). The width of at least a portion of container latch channel 320 can be approximately equal to the width of at least a corresponding portion of container rim 220. Alternatively or in addition, the width of at least a portion of container latch channel 320 can be less than the width of the corresponding portion of container rim 220. The height of container latch channel 320 may be any suitable distance that allows for container rim 220 to engage with latch channel 320 (e.g., 0.15-0.65 inches). According to certain embodiments, container latch channel 320 may include a protrusion 382 on top wall 380. In various embodiments, protrusion 382 may be trapezoidal, rectangular, triangular, semi-circular, or circular in cross-sectional shape. In these embodiments (and others), when container 200 engages with ring 300, protrusion 382 can abut, deform, or otherwise engage with container 200 (e.g., an end surface of container rim 220) to ensure a tight fit between container 200 and ring 300.

In various embodiments, a latch protrusion 312 is located on the interior surface 332 and includes latch surface 304. The latch protrusion 312 can be or comprise a protrusion extending outwardly from the interior surface 332, as illustrated in FIGS. 3A-3C. According to certain embodiments, latch protrusion 312 may be located on the outermost sidewall 308 and protrudes into container latch channel 320 (e.g., extending from the interior surface 332 in a radially inward direction). In various embodiments and as shown in FIG. 3A, latch protrusion 312 is trapezoidal in shape. According to some embodiments, latch protrusion 312 may be triangular, rectangular, semi-circular, or circular in shape. As will be understood from discussions herein, container latch channel 320 can at least partially receive container rim 220. Latch protrusion 312 engages with latch tab 224 to create a liquid-tight seal between container 200 and ring 300. In particular, embodiments, and as will be discussed further herein, latch protrusion 312 engages with latch tab 224 to fold latch tab 224 flat against outer surface 260 upon insertion of the container rim 220 into container latch channel 320.

In various embodiments, latch surface 304 includes a surface portion 306. The surface portion 306 can be configured to initially contact or engage latch tab 224 or another portion of the container 200 upon insertion of the container rim 220 into container latch channel 320. Initial surface portion 306 can be sloped, as in FIGS. 3A-3C. In at least one embodiment, surface portion 306 extends between the interior surface 332 of sidewall 308 and the peak (e.g., the most radially inward portion) of latch protrusion 312. According to various embodiments, sloped surface 306 is a flat, inclined surface. Alternatively, surface portion 306 can be rounded. The sloped or rounded nature of the surface portion 306 can bias or deform at least a portion of the container 200 (e.g., latch tab 224) upon insertion of the container rim 220 into container latch channel 320 and/or can bias or deform at least a portion of the ring 300 (e.g., sidewall 308) to accommodate a corresponding portion of the container 200 (e.g., container rim 220) in container latch channel 320. In certain embodiments, surface portion 306 facilitates folding latch tab 224 flat against outer surface 260. In particular embodiments, sloped surface 306 facilitates folding latch tab 224 flat against outer surface 260 by engaging latch tab 224 such that surface portion 306 gradually applies pressure to latch tab 224. In these embodiments (and others), the gradual pressure applied by surface portion 306 allows latch tab 224 to fold ninety degrees without snapping. In some embodiments, once folded ninety degrees, latch tab 224 is secured against latch surface 304 such that ring 300 and container 200 form a liquid-tight seal that does not require adhesives or additional sealing materials (e.g., gaskets). In various embodiments, surface portion 306 connects with edge 310 of sidewall 308. In particular embodiments, edge 310 is parallel to top wall 380. In at least one embodiment, the width of edge 310 is less than the thickness of sidewall 308. In some embodiments, the width of edge 310 is equal to the thickness of sidewall 308.

Continuing with the embodiment shown in FIGS. 3A-3C, the ring 300 includes a lid latch channel 340. In the embodiment shown in FIG. 3A, lid latch channel 340 is formed by two sidewalls 330 and 325 and bottom wall 316. In various embodiments, lid latch channel 340 may be generally U-shaped. In some embodiments, lid latch channel 340 may be trapezoidal or rectangular in cross-sectional shape. As will be understood from discussions herein, lid latch channel 340 receives at least a portion of a lid (e.g., lid 400 as discussed in relation to FIG. 1) to create a seal between ring 300 and the lid. The width of lid latch channel 340 may be any suitable distance that allows for lid latch channel 340 to receive the lid (e.g., 0.5-1.5 inches). For example, the width of at least a portion of lid latch channel 340 can be approximately equal to the width of at least a corresponding portion of the lid. Alternatively or in addition, the width of at least a portion of lid latch channel 340 can be less than the width of the corresponding portion of the lid. The height of lid latch channel 340 may be any suitable distance that allows for container rim 220 to engage with lid latch channel 340 (e.g., 0.2-0.5 inches).

According to various embodiments, sidewall 325 includes side surface 318 and/or side surface 334. In certain embodiments, sidewall 325 ends at edge 360. In various embodiments, sidewall 325 includes a surface 322 that is sloped and/or rounded in a downwardly direction (e.g., from edge 360 in a radially inward direction towards the center of ring 300). In embodiments that include sloped surface 322 and as shown in FIG. 3A, edge 360 of sidewall 325 is trapezoidal in cross-sectional shape.

In various embodiments, sidewall 325 includes ring bead 326. In one or more embodiments, ring bead 326 protrudes into lid latch channel 340. In some embodiments, and as will be understood from discussions herein, lid latch channel 340 at least partially receives the lid. In particular embodiments, ring bead 326 engages with a surface of the lid to create a liquid-tight seal between ring 300 and the lid. In various embodiments and as shown in FIG. 3A, ring bead 326 is trapezoidal in cross-sectional shape. According to some embodiments, ring bead 326 may be triangular, rectangular, semi-circular, or circular in cross-sectional shape. In various embodiments and as shown in FIG. 3A, ring bead 326 is located a suitable distance between the top and bottom of sidewall 325 (e.g., 0.01-0.46 inches).

In various embodiments, ring 300 includes sloped surface 314. In some embodiments, at least a portion of the sloped surface 314 is located at, near, or on the bottom portion of ring 300 and connects to interior surface 332. In various embodiments, sloped surface 314 facilitates container latch channel 320 receiving container rim 220. More specifically, in at least one embodiment, sloped surface 314 allows container rim 220 and container body 210 to slide across ring 300 and into container latch channel 320. Further, in various embodiments, the bottom portion of ring 300 includes underside surface 370. In some embodiments, sloped surface 314 connects interior surface 332 to underside surface 370. Stated otherwise, the edge separating the interior surface 332 and the underside surface 370 can be chamfered. Alternatively, the edge separating the interior surface 332 and the underside surface 370 can be curved or rounded. In various embodiments, underside surface 370 is a flat surface that is generally parallel to bottom wall 316.

Now referring to FIG. 3B, a cross-sectional view of an exemplary ring 300 and container 200 is shown. According to the embodiment shown in FIG. 3B, ring 300 is shown immediately prior to engaging container 200 (e.g., portions of the ring 300 are abutting or otherwise in contact with the container 200 but the ring 300 is not yet attached to the container 200). In various embodiments, container rim 220 and latch tab 224 line up with the opening of container latch channel 320. In particular embodiments, sidewall 212 is partially flush with interior surface 332, and latch tab 224 is in contact with edge 310. According to various embodiments and as shown in FIG. 3B, latch tab 224 is partially flush with edge 310 or otherwise in contact with edge 310 and/or sloped surface 306. In some embodiments, latch tab 224 may be entirely flush with edge 310. In various embodiments, edge 310 is parallel to latch tab 224 immediately prior to ring 300 engaging container 200.

Now referring to FIG. 3C, a cross-sectional view of an exemplary ring 300 and container 200 in an attached configuration is shown. According to various embodiments, once the corresponding seal structures on ring 300 and container 200 are aligned, ring 300 may be attached to container 200 by applying pressure or force to either or both container 200 and ring 300 such that container latch channel 320 at least partially receives container rim 220. As shown in FIG. 3C, container latch channel 320 can at least receive container rim 220. In particular embodiments, and as discussed in reference to FIG. 3B, container rim 220 and latch tab 224 line up with the opening of container latch channel 320 and latch tab 224 is in contact with edge 310 and/or sloped surface 306. In these embodiments (and others), once pressure or force is applied to either or both container 200 and ring 300, sloped surface 306 engages with latch tab 224 such that sloped surface 306 transfers pressure to latch tab 224 and biases latch tab 224 downward. In various embodiments, the pressure transferred by sloped surface 306 allows latch tab 224 to bend or fold downwardly (e.g., ninety degrees relative the starting position of the latch tab 224 shown in FIG. 3A, for example) without snapping or cracking. In some embodiments, sloped surface 306 and/or latch surface 304 fold latch tab 224 such that at least a portion of latch tab 224 is flush against, or otherwise in contact with, outer surface 260. In at least one embodiment, once folded downward, latch tab 224 is secured against latch surface 304 such that latch surface 304 prevents container rim 220 from sliding out of container latch channel 320. Further, in some embodiments, protrusion 382 deforms container rim 220 slightly to ensure a tight-fit between container rim 220 and container latch channel 320.

In various embodiments, the seal formed by container rim 220 engaging container latch channel 320 is a liquid-tight seal between ring 300 and container 200 that requires no adhesives or additional sealing materials (e.g., a separate O-ring). In particular embodiments, this liquid-tight seal may be formed simply by lining up container rim 220 and container latch channel 320 and applying pressure or force to either or both container 200 and ring 300. In at least one embodiment, no adhesives or additional sealing materials are necessary to attach container 200 to ring 300. In certain embodiments, this liquid-tight seal provides significant advantages such as decreasing the cost of production and materials and the time necessary to assemble. In these embodiments (and others), the folding latch tab 224 allows for container 200 and ring 300 to be manufactured from lower costs materials such as plastic (e.g., Polyethylene, Polyethylene Terephthalate (PET), High-Density Polyethylene (HDPE), Polyvinyl Chloride (PVC), Low-Density Polyethylene (LDPE), Polypropylene (PP), Polystyrene (PS), etc.). In several embodiments, the liquid-tight seal allows container 200 to be used to store various liquids and other materials, including, but not limited to: paints, oils, food, consumer goods, construction materials, inks, chemicals, lubricants, adhesives, coatings, roofing mastics, driveway sealers, flavorings, sanitation supplies, building products, ice melt compounds, powders, pet food, and other such materials.

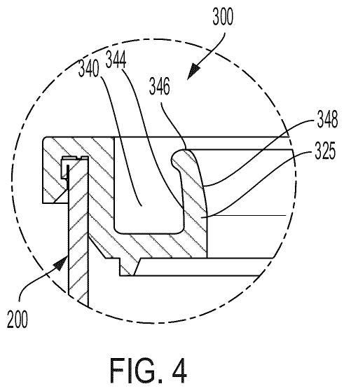

Now referring to FIG. 4, a cross-sectional view of an exemplary ring 300 and container 200 in an attached configuration is shown. According to some embodiments, and as show in FIG. 4, lid latch channel 340 includes sidewall 325. In at least one embodiment, sidewall 325 is similar, as discussed in relation to FIG. 3A, to sidewall 325. In some embodiments, sidewall 325 includes outer surface or wall 344 and inner surface or wall 348. In the embodiment shown in FIG. 4, sidewall 325 curves into lid latch channel 340. Further, in at least one embodiment, sidewall 325 includes a rounded top 346. In the embodiment shown in FIG. 4, at least some of rounded top 346 is circular (or semi-circular) in cross-sectional shape. Further, in particular embodiments, rounded top 346 is located at the top of sidewall 325 and connects outer wall 344 and inner wall 348. In various embodiments and as shown in FIG. 4, rounded top 346 protrudes into lid latch channel 340. In some embodiments, rounded top 346 protrudes into lid latch channel 340 due in part to the curvature of sidewall 325. In at least one embodiment, sidewall 325 does not curve into lid latch channel 340 and rounded top 346 is trapezoidal in cross-sectional shape. In at least one embodiment, rounded top 346 has a width equal to sidewall 325. In some embodiments, and as shown in FIG. 4, rounded top 346 has a width greater than sidewall 325. According to various embodiments and to be discussed further herein, rounded top 346 engages with a corresponding seal structure on a lid (e.g., lid 400 as discussed in relation to FIG. 1), such that a liquid-tight seal may be formed between ring 300 and the lid. While sidewall 325 is illustrated as extending and/or leaning or curving at least partially in a radially outward direction, the disclosed technology is not so limited. Alternatively, sidewall 325 can extend and/or lean or curve at least partially in a radially inward direction.

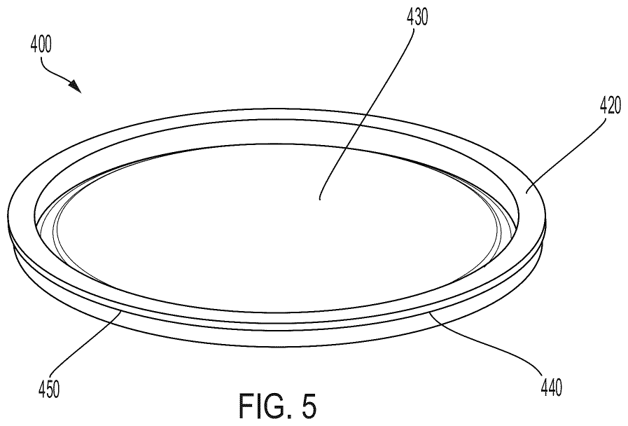

Now referring to FIG. 5, a perspective view of an exemplary lid 400 is shown. According to various embodiments and to be discussed further herein, lid 400 engages with a container ring (e.g., ring 300 as discussed in relation to FIG. 1) to form a liquid-tight seal without any adhesives or additional sealing materials (e.g., gaskets). In various embodiments, lid 400 includes ring latch channel 450. According to various embodiments, some or all of the ring latch channel 450 may be U-shaped, trapezoidal, or rectangular in cross-sectional shape (or any combination thereof). As will be understood from discussions herein and in particular embodiments, ring latch channel 450 facilitates a liquid-tight seal with a container ring.

In one or more embodiments, lid 400 includes top surface 420 and ledge 440. In various embodiments, ledge 440 is continuous with top surface 420. In some embodiments, both top surface 420 and ledge 440 are located above ring latch channel 450. In various embodiments, the width of top surface 420 is greater than the width of ring latch channel 450. In various embodiments, lid 400 further includes top 430. In certain embodiments, top 430 is a flat surface that is parallel to both top surface 420 and ledge 440. In at least one embodiment and as shown in FIG. 5, top 430 is circular and located in the center of lid 400. In some embodiments, top 430 may be rectangular, square, or trapezoidal in cross-sectional shape.

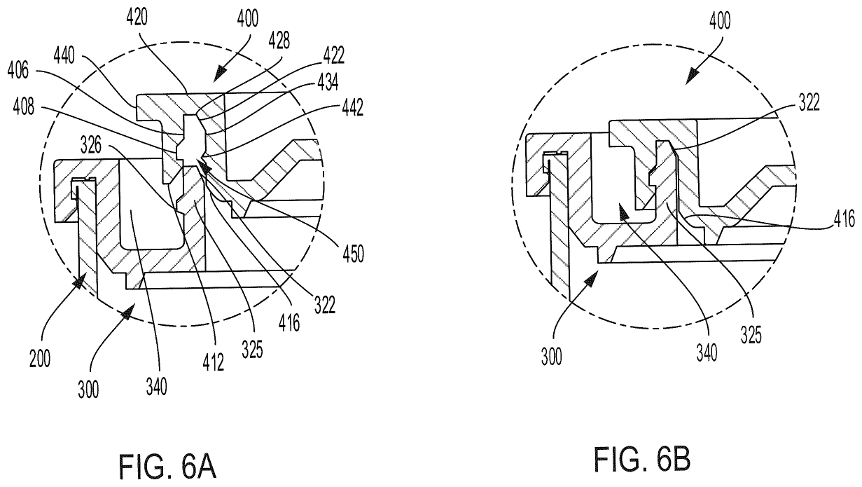

Now referring to FIG. 6A, a cross-sectional view of an exemplary container 200 and ring 300 immediately prior to engagement with lid 400 is shown, according to one embodiment of the present disclosure. In particular embodiments, ring 300 includes sidewall 325, lid latch channel 340, and ring bead 326. In one or more embodiments, sidewall 325 is similar, as discussed in relation to FIG. 3A, to sidewall 325. In one or more embodiments, lid latch channel 340 is similar, as discussed in relation to FIG. 3A, to lid latch channel 340. In certain embodiments, ring bead 326 is similar, as discussed in relation to FIG. 3A, to ring bead 326. In various embodiments, sidewall 325 is trapezoidal in shape and includes sloped surface 322. In particular embodiments, sloped surface 322 is located on the inner side of sidewall 325.

According to various embodiments, lid 400 includes ring latch channel 450. In the embodiment shown in FIG. 6A, ring latch channel 450 is defined at least in part by sidewall 406, sidewall 434, and top wall 428. In various embodiments, at least a portion of ring latch channel 450 may be U-shaped when viewed in cross-section. In some embodiments, at least a portion of ring latch channel 450 may be trapezoidal or rectangular in cross-sectional shape. In one or more embodiments, and as will be understood from discussions herein, ring latch channel 450 receives sidewall 325 to create a seal between lid 400 and ring 300. In various embodiments, ring latch channel 450 is shaped such that it may receive and engage with sidewall 325. That is to say, the geometry and size of sidewall 406 can substantially mirror, and/or be configured to mate with, a first corresponding surface (e.g., side surface 318) of the ring 300, and/or the geometry and size of sidewall 434 can substantially mirror, and/or be configured to mate with, a second corresponding surface (e.g., side surface 334) of the ring 300. In some embodiments, the width of ring latch channel 450 may be any suitable distance that allows for ring latch channel 450 to receive sidewall 325 (e.g., 0.3-0.7 inches). In certain embodiments, the height of ring latch channel 450 may be any suitable distance that allows for ring latch channel 450 to engage with ring bead 326 (e.g., 0.3-0.5 inches).

In various embodiments, sidewall 406 includes latch recess 408, which is or includes an indentation into sidewall 406. As will be understood from discussions herein, in particular embodiments, latch recess 408 engages with ring bead 326 to create a liquid-tight seal between ring 300 and lid 400. In various embodiments and as shown in FIG. 6A, latch recess 408 is at least partially trapezoidal in cross-sectional shape. In the embodiment shown in FIG. 6A, latch recess 408 is trapezoidal in cross-sectional shape such that latch recess 408 may engage with ring bead 326, which is also trapezoidal in cross-sectional shape. According to some embodiments, latch recess 408 may be triangular, rectangular, semi-circular, or circular in cross-sectional shape. The cross-sectional shape of the latch recess 408 can be the same as the cross-sectional shape of the ring bead 326. Alternatively, the cross-sectional shape of the latch recess 408 can be different from the cross-sectional shape of the ring bead 326. In various embodiments and as shown in FIG. 6A, latch recess 408 is located a suitable distance between the top and bottom of sidewall 406 (e.g., 0.1-0.4 inches). In various embodiments, latch recess 408 is located at the top of sidewall 406. In some embodiments, latch recess 408 is located at or near the bottom of sidewall 406 (e.g., nearer the bottom of sidewall 406 than the top of sidewall 406).

In various embodiments and in the embodiment shown in FIG. 6A, ring latch channel 450 includes protrusion 442. Specifically, in certain embodiments, protrusion 442 is located on sidewall 434 and protrudes into ring latch channel 450. According to various embodiments, at least a portion of protrusion 442 may be trapezoidal, triangular, rectangular, semi-circular, or circular in cross-sectional shape. In at least one embodiment, when lid 400 engages with ring 300, protrusion 442 slightly deforms sidewall 325 such that lid 400 is tightly fit on ring 300.

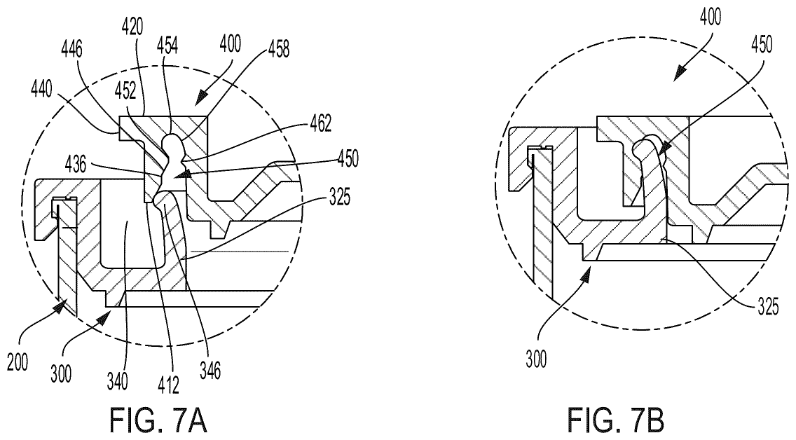

In various embodiments and in the embodiment shown in FIG. 6A, ring latch channel 450 is trapezoidal in shape. In the embodiment shown, sloped surface 422 connects top wall 428 to sidewall 434. In some embodiments, sloped surface 422 connects top wall 428 to sidewall 406. In various embodiments, the shape (e.g., trapezoidal) of ring latch channel 450 ensures a tight fit with ring bead 326, which can have the same shape (e.g., trapezoidal) as the ring latch channel 450 or a shape different (e.g., rounded or semi-circular) from that of the lid latch channel. In some embodiments, and as will be discussed in reference to FIGS. 7A and 7B, a U-shape shape of ring latch channel 450 ensures a tight fit with ring bead 326, which can be circular (or semi-circular) in cross-sectional shape as a non-limiting example. In particular embodiments, sloped surface 322 of sidewall 325 engages with sloped surface 422 to ensure a liquid-tight seal without adhesives or additional materials (e.g., gaskets).

According to various embodiments, edge 412, located at the bottom of sidewall 406 may also be trapezoidal in cross-sectional shape. In some embodiments, edge 412 may be triangular, rectangular, semi-circular, or circular in cross-sectional shape. Further, in various embodiments, edge 412, located at the bottom of sidewall 434 may be curved or sloped. In some embodiments, edge 412 may be a rounded or sharp corner. In particular embodiments, lid 400 may include top surface 420 and ledge 440. In various embodiments, ledge 440 is continuous with top surface 420. Both top surface 420 and ledge 440 are located above ring latch channel 450. In various embodiments, the width of top surface 420 is greater than the width of ring latch channel 450. According to various embodiments, ledge 440 protrudes over some or all of the opening to lid latch channel 340 when lid 400 is attached to ring 300.

In various embodiments, lid 400 includes sloped surface 416. In these embodiments (and others), sloped surface 416 is located on the bottom portion of lid 400 and connects to sidewall 434. In various embodiments, sloped surface 416 facilitates receipt of sidewall 325 by ring latch channel 450. More specifically, in at least one embodiment, sloped surface 416 allows sloped surface 322 and sidewall 325 to slide across lid 400 and into ring latch channel 450.

Continuing with the embodiment shown in FIG. 6A, ring 300 and container 200 are in an attached configuration, and lid 400 is shown immediately before attachment to ring 300 (e.g., portions of the lid 400 are abutting or otherwise in contact with the ring 300 but the lid 400 is not yet attached to the ring 300). In various embodiments, the top portion of sidewall 325 is aligned with ring latch channel 450 such that ring latch channel 450 may at least partially receive sidewall 325.

Referring now to FIG. 6B, a cross-sectional view of an exemplary container 200, ring 300, and lid 400 in an attached configuration is shown, according to one embodiment of the present disclosure. According to various embodiments, once the corresponding seal structures on lid 400 and ring 300 are aligned, lid 400 may be attached to ring 300 by applying pressure or force to ring 300, container 200, or lid 400, either alone or in combination. As shown in FIG. 6B, in one embodiment, ring latch channel 450 at least partially receives sidewall 325. In particular embodiments, the top of sidewall 325 is aligned with ring latch channel 450. In certain embodiments, sloped surface 322 may slide along sloped surface 416 to allow case of attachment. In various embodiments, once pressure or force is applied to ring 300, container 200, and lid 400, either alone or in combination, ring bead 326 engages with latch recess 408. Specifically, in some embodiments, ring bead 326 fits inside latch recess 408 such that sidewall 325 may not easily slide out of ring latch channel 450. Further, in one or more embodiments, protrusion 442 deforms sidewall 325 slightly such that lid 400 is securely attached to ring 300. In certain embodiments, once lid 400 is attached to ring 300, lid 400 and ring 300 form a liquid-tight seal that requires no adhesives or additional sealing materials. In particular embodiments, once ring 300 is attached to container 200 and lid 400 is attached to ring 300, the combination of container 200, ring 300, and lid 400 form an enclosed space with a liquid-tight seal. In these embodiments (and others), the liquid-tight seal allows container 200 to be used to store various liquids and other materials, including, but not limited to: paints, oils, food, consumer goods, construction materials, inks, chemicals, lubricants, adhesives, coatings, roofing mastics, driveway sealers, flavorings, sanitation supplies, building products, ice melt compounds, powders, pet food, and/or other such materials.

Further, in certain embodiments, lid 400 can be detached from ring 300 to allow the inside of container 200 to be accessed. In particular embodiments, upward force or pressure may be applied to ledge 440 to facilitate detachment. Once upward force or pressure is applied to ledge 440, in some embodiments, ring bead 326 disengages with latch recess 408 and sidewall 325 may slide out of ring latch channel 450. In one or more embodiments, once sidewall 325 begins to slide out of ring latch channel 450, sloped surface 322 slides across and/or away from sloped surface 416 to remove lid 400 from ring 300 without damage to either lid 400 or ring 300.

Referring now to FIG. 7A, a cross-sectional view of an exemplary container 200 and ring 300 immediately prior to engaging lid 400 is shown (e.g., portions of the ring 300 are abutting or otherwise in contact with the container 200 but the ring 300 is not yet attached to the container 200). In some embodiments, ring 300 includes sidewall 325 and lid latch channel 340. In the embodiment shown in FIG. 7A, sidewall 325 curves into lid latch channel 340. Further, in at least one embodiment, sidewall 325 includes rounded top 346. In the embodiment shown in FIG. 7A, rounded top 346 is circular (or semi-circular) in cross-sectional shape. Further, in some embodiments, rounded top 346 is located at the top of sidewall 325. In various embodiments and as shown in FIG. 7A, rounded top 346 protrudes into lid latch channel 340. In at least one embodiment, rounded top 346 has a width equal to sidewall 325. In some embodiments, and as shown in FIG. 7A, rounded top 346 has a width greater than sidewall 325.

In various embodiments, lid 400 includes ring latch channel 450. According to various embodiments and as shown in FIG. 7A, ring latch channel 450 is U-shaped. In some embodiments, ring latch channel 450 may be trapezoidal or rectangular in cross-sectional shape. As will be understood from discussions herein, and in particular embodiments, ring latch channel 450 at least partially receives sidewall 325 to create a seal between lid 400 and ring 300. In various embodiments, ring latch channel 450 is shaped such that it may at least partially receive, and/or engage with, sidewall 325. In various embodiments and as shown in FIG. 7A, ring latch channel 450 includes sidewalls 458 and 446 as well as latch surface 454. In at least one embodiment, latch surface 454 is curved to facilitate engagement with rounded top 346. Further, in various embodiments, latch surface 454 connects sidewalls 458 and 446.

In various embodiments, sidewall 446 includes either or both latch notch 436 and latch protrusion 452. In various embodiments, latch notch 436 is an indentation into sidewall 446. According to various embodiments, latch notch 436 may be trapezoidal, triangular, semi-circular, circular, or rectangular in cross-sectional shape. In at least one embodiment and as shown in FIG. 7A, latch notch 436 is located a suitable distance below latch protrusion 452 (e.g., 0.1-0.4 inches). In various embodiments, latch protrusion 452 protrudes into ring latch channel 450 and is located above latch notch 436 and latch surface 454. In various embodiments, latch protrusion may be trapezoidal, triangular, semi-circular, circular, or rectangular in cross-sectional shape. In various embodiments, and as will be understood from the discussions herein, both latch notch 436 and latch protrusion 452 engage with sidewall 325 and rounded top 346 to create a liquid-tight seal without any adhesives or additional sealing materials (e.g., gaskets).

In various embodiments, sidewall 458 includes protrusion 462. Specifically, in at least one embodiment, protrusion 462 protrudes slightly into ring latch channel 450. According to various embodiments, protrusion 462 may be trapezoidal, triangular, rectangular, semi-circular, or circular in cross-sectional shape. In at least one embodiment, when lid 400 engages with ring 300, protrusion 462 slightly deforms sidewall 325 such that lid 400 is tightly fit on ring 300.

As previously mentioned with respect to FIG. 4, sidewall 325 is illustrated as extending and/or leaning or curving at least partially in a radially outward direction, but the disclosed technology is not so limited. Alternatively, sidewall 325 can extend and/or lean or curve at least partially in a radially inward direction. In such an instance, the geometry of the ring latch channel 450 can be mirrored from the configuration illustrated in FIGS. 7A and 7B. For example, one or more of the various features or elements described herein as being located on the sidewall 446 can instead be located on the sidewall 458, and/or one or more of the various features or elements described herein as being located on the sidewall 458 can instead be located on the sidewall 446.

According to various embodiments, edge 412, located at the bottom of sidewall 446, may be trapezoidal in cross-sectional shape. In some embodiments, edge 412 may be triangular, rectangular, semi-circular, or circular in cross-sectional shape. Further, in various embodiments, edge 412, located at the bottom of sidewall 446 may be curved or sloped. In some embodiments, edge 412 may be a rounded or sharp corner. In particular embodiments, lid 400 may include top surface 420 and ledge 440. In various embodiments, ledge 440 is integral and continuous with top surface 420. In several embodiments, both top surface 420 and ledge 440 are located above ring latch channel 450. In various embodiments, the width of top surface 420 is greater than the width of ring latch channel 450. According to various embodiments, ledge 440 protrudes over the opening to lid latch channel 340 when lid 400 is attached to ring 300.

Continuing with the embodiment shown in FIG. 7A, ring 300 and container 200 are in an attached configuration and lid 400 is shown immediately before attachment to ring 300. In various embodiments, the top portion of sidewall 325 is aligned with ring latch channel 450 such that ring latch channel 450 may receive sidewall 325 such that lid 400 may be attached to ring 300.

Referring now to FIG. 7B, a cross-sectional view of an exemplary container 200, ring 300, and lid 400 in an attached configuration is shown, according to one embodiment of the present disclosure. According to various embodiments, once the corresponding seal structures on lid 400 and ring 300 are aligned, lid 400 may be attached to ring 300 by applying pressure or force to ring 300, container 200, or lid 400, either alone or in combination. As shown in FIG. 7B, in some embodiments, ring latch channel 450 at least partially receives sidewall 325. In particular embodiments, rounded top 346 is aligned with ring latch channel 450. In certain embodiments, edge 412 may facilitate in guiding rounded top 346 into ring latch channel 450 such that rounded top 346 slides into ring latch channel 450 without resistance (or without substantial resistance). In various embodiments, once pressure or force is applied to ring 300, container 200, and lid 400, either alone or in combination, rounded top engages with latch surface 454 and latch protrusion 452. Specifically, in at least one embodiment, due to the curved nature of sidewall 325, rounded top 346 applies pressure to latch surface 454 and latch protrusion 452. In or more embodiments, sidewall 325 slightly deforms latch protrusion 452 and rounded top 346 fits in latch surface 454 such that sidewall 325 may not slide out of ring latch channel 450. Further, in some embodiments, protrusion 462 slightly deforms sidewall 325 such that lid 400 is securely attached to ring 300.

In particular embodiments, once lid 400 is attached to ring 300, lid 400 and ring 300 form a liquid-tight seal that requires no adhesives or additional sealing materials. In certain embodiments, once ring 300 is attached to container 200 and lid 400 is attached to ring 300, container 200, ring 300, and lid 400 form an enclosed space with a liquid-tight seal. In some embodiments, the liquid-tight seal allows container 200 to be used to store various liquids and other materials, including, but not limited to: paints, oils, food, consumer goods, construction materials, inks, chemicals, lubricants, adhesives, coatings, roofing mastics, driveway sealers, flavorings, sanitation supplies, building products, ice melt compounds, powders, pet food, and other such materials.

Further, in certain embodiments, lid 400 can easily be detached from ring 300 to allow the inside of container 200 to be accessed. In particular embodiments, upward force or pressure may be applied to ledge 440 to facilitate detachment. In these embodiments (and others), once upward force or pressure is applied to ledge 440, rounded top 346 disengages with latch notch 436 and latch surface 454 and sidewall 325 may slide out of ring latch channel 450.

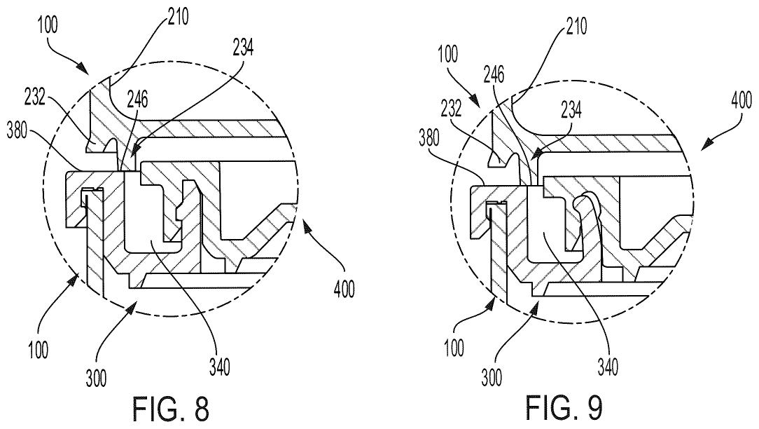

Referring now to FIG. 8, a cross-sectional view of a first exemplary container 200 stacked on top of a second exemplary container 200 in an attached configuration with ring 300 and lid 400 is shown, according to one embodiment of the present disclosure. According to various embodiments, container 200 may include lower leg 234. In some embodiments, lower leg 234 extends below container body 210; in some embodiments, at least some of lower leg 234 extends parallel to the sidewall of container body 210. In various embodiments, lower leg 234 may be a suitable length such that container 200 would not tip over (e.g., 0.1-0.5 inches). In various embodiments, lower leg 234 includes base 246 located on the bottom of lower leg 234. In various embodiments, base 246 is a flat surface that provides support to container 200 when rested on a surface.

According to various embodiments, container 200 may also include upper leg 232. In various embodiments, upper leg 232 also extends below container body 210. In some embodiments, upper leg 232 slopes away from container body 210 such that upper leg 232 and lower leg 234 form a groove on the bottom of container body 210. As discussed further herein and in at least one embodiment, upper leg 232 and lower leg 234 provide stability and load distribution when stacking container 200 on top of container 200 with ring 300 and lid 400 attached. In particular embodiments, upper leg 232 may provide stability and load distribution by preventing container 200 from falling over in the case of tipping.

In various embodiments and as shown in FIG. 8, ring 300 includes top surface 380. In at least one embodiment and as shown in FIG. 8, a portion of base 246 rests on top surface or wall 380 such that container 200 is stacked on top of container 200. In some embodiments, a portion of base 246 rests above lid latch channel 340. In various embodiments, base 246 may rest entirely on top surface 380. In particular embodiments, base 246 may fit into, and/or at least partially extend into, lid latch channel 340 (e.g., when the container assembly 100 of which base 246 is a part is stacked atop another container assembly 100).

Referring now to FIG. 9, a cross-sectional view of a first exemplary container 200 stacked on top of a second exemplary container 200 in an attached configuration with ring 300 and lid 400 is shown, according to one embodiment of the present disclosure.

According to various embodiments, container 200 may include lower leg 234. In one or more embodiments, lower leg 234 extends below and runs parallel to container body 210. In various embodiments, lower leg 234 may be a suitable length such that container 200 would not tip over (e.g., 0.1-0.5 inches). In one embodiment, lower leg 234 includes base 246 located on the bottom of lower leg 234. In various embodiments, base 246 is a flat surface that provides support to container 200 when rested on a surface.

According to various embodiments, container 200 may also include upper leg 232. In various embodiments, upper leg 232 also extends below container body 210. In certain embodiments, upper leg 232 slopes away from container body 210 such that upper leg 232 and lower leg 234 form a groove on the bottom of container body 210. In one or more embodiments, and as discussed further herein, upper leg 232 and lower leg 234 provide stability and load distribution when stacking container 200 on top of container 200 with ring 300 and lid 400 attached. In particular embodiments, upper leg 232 may provide stability and load distribution by preventing container 200 from falling over in the case of tipping.

In various embodiments and as shown in FIG. 9, ring 300 includes top surface 380. In at least one embodiment and as shown in FIG. 9, a portion of base 246 rests on top surface 380 such that container 200 is stacked on top of container 200. In certain embodiments, a portion of base 246 rests above lid latch channel 340. In various embodiments, base 246 may rest entirely on top surface 380. In particular embodiments, base 246 may fit into, and/or at least partially extend into, lid latch channel 340 (e.g., when the container assembly 100 of which base 246 is a part is stacked atop another container assembly 100).

Accordingly, it will be readily understood by those persons skilled in the art that, in view of the above detailed description of the various embodiments and articles of the present disclosure, the present disclosure is susceptible of broad utility and application. Many methods, embodiments, and adaptations of the present disclosure other than those herein described, as well as many variations, modifications, and equivalent arrangements will be apparent from or reasonably suggested by the present disclosure and the above detailed description thereof, without departing from the substance or scope of the present disclosure. Accordingly, while the present disclosure is described herein in detail in relation to various embodiments, it is to be understood that this detailed description is only illustrative and exemplary of the present disclosure and is made for purposes of providing a full and enabling disclosure of the present disclosure. The detailed description set forth herein is not intended nor is to be construed to limit the present disclosure or otherwise to exclude any such other embodiments, adaptations, variations, modifications, and equivalent arrangements of the present disclosure. The scope of the present disclosure is defined solely by the claims appended hereto and the equivalents thereof.

What is claimed is:

1. A container assembly, comprising:
a container comprising:
a bottom surface; and
at least one sidewall circumscribing the bottom surface, wherein the at least one sidewall extends in a vertical direction from the bottom surface to an upper end thereby forming a cavity, the upper end comprising an attachment portion and a latch tab extending from the attachment portion in a radial direction;
a ring comprising:
a container latch channel for at least partially receiving the attachment portion of the container, wherein the container latch channel comprises an outer container latch channel (CLC) side, an inner CLC side, and a top CLC side;
a lid latch for engaging a lid, the lid latch comprising an inner lid latch side, a distal lid latch edge, and an outer lid latch side; and
a bottom wall extending between the inner CLC side and the outer lid latch side, wherein at least the inner CLC side, the bottom wall, and the outer lid latch side form a lid latch channel; and
the lid comprising:
a ring latch channel for at least partially receiving the lid latch of the ring,
wherein the latch tab is configured to fold downwardly when the container latch channel at least partially receives the sidewall.

2. The container assembly of claim 1, wherein the container latch channel comprises a CLC protrusion extending from the top CLC side into the container latch channel, the CLC protrusion for engaging the upper end of the container.

3. The container assembly of claim 2, wherein the CLC protrusion is substantially rectangular in shape.

4. The container assembly of claim 1, wherein the outer CLC side comprises one or more latch surfaces comprising:
a sloped surface extending in a sloped direction into the container latch channel.

5. The container assembly of claim 4, wherein the sloped surface forms at least part of a latch protrusion for engaging latch tab.

6. The container assembly of claim 5, wherein the latch protrusion has a substantially trapezoidal cross-sectional shape.

7. The container assembly of claim 1, wherein the ring further comprises an underside surface, wherein an edge between the inner CLC side and the underside surface is rounded or chamfered.

8. The container assembly of claim 1, wherein the bottom surface is substantially round.

9. The container assembly of claim 1, wherein a thickness of the at least one sidewall of the container is less than a width of the container latch channel.

10. The container assembly of claim 1, wherein the container is a first single component, the ring is a second single component, and the lid is a third single component.

11. The container assembly of claim 1, wherein attachment of the ring to the container forms a liquid-tight seal between the ring and the container.

12. The container assembly of claim 1, wherein attachment of the lid to the ring forms a liquid-tight seal between the lid and the ring.

13. A system for sealing a container, comprising:
a ring for engaging the container, the ring comprising:
a container latch channel for accepting a portion of the container;
a lid latch for engaging with a lid, the lid latch comprising an inner lid latch side and an outer lid latch side, wherein at least a portion of the lid latch extends in a radial direction; and
a bottom wall extending between an inner wall of the container latch channel and the lid latch, wherein at least the inner wall of the container latch channel, the bottom wall, and the lid latch form a lid latch channel; and
the lid comprising:
a ring latch channel for at least partially receiving the lid latch of the ring, wherein the ring latch channel comprises an inner ring latch sidewall, an outer ring latch sidewall, and a top ring latch surface, wherein a width of the inner ring latch sidewall increases from a first diameter at a bottom of the inner ring latch sidewall to second diameter at a latch notch and decreases from the second diameter to a third diameter proximate the top ring latch surface.

14. The system of claim 13, wherein an upper portion of the outer lid latch side is substantially convex.

15. The system of claim 13, wherein the top ring latch surface is substantially rounded.

16. The system of claim 15, wherein the radial direction is radially outward.

17. The system of claim 13, wherein the inner ring latch sidewall comprises a ridged surface.

18. The system of claim 13, wherein the ring further comprises:
a ring bead protrusion on the outer lid latch side, wherein the ring bead protrusion extends into the lid latch channel.

19. The system of claim 18, wherein the ring bead protrusion has a substantially trapezoidal cross-sectional shape.

20. The system of claim 19, wherein the inner ring latch sidewall comprises a recess for engaging the ring bead protrusion.

21. The system of claim 13, wherein the outer ring latch sidewall comprises a latch protrusion for engaging the ring latch channel.
